(19) United States
(12) Patent Application Publication
(10) Pub. No.: US 2015/0248851 A1
(43) Pub. Date: Sep. 3, 2015

(54) MOUNTING ASSEMBLIES

(71) Applicant: SUN PEAK DEVELOPMENT, LLC, Ashton, ID (US)

(72) Inventors: Curtis L. Stoddard, Ashton, ID (US); Joe A. Bolinder, Tooele, UT (US)

(21) Appl. No.: 14/636,637

(22) Filed: Mar. 3, 2015

Related U.S. Application Data
(60) Provisional application No. 61/947,416, filed on Mar. 3, 2014.

(51) Int. Cl. G09F 7/18; F16M 13/02; F16M 11/04

(52) U.S. Cl. CPC G09F 7/18; F16M 11/04; F16M 13/02; G09F 2007/1817

(57) ABSTRACT

Mounting assemblies for mounting objects to posts. A mounting assembly includes a tubular body, one or more post fasteners, and one or more object fasteners. The tubular body bounds a central aperture and the body and the central aperture extend longitudinally from a bottom end to a top end. The tubular body has a front side and a back side. The post fasteners are attachable to the back side of the tubular body and are configured to removably secure the tubular body to a post. The object fasteners are attachable to the front side of the tubular body and are configured to removably secure an object to the tubular body.

### CROSS-REFERENCE TO RELATED APPLICATIONS

This application claims priority to U.S. Provisional Patent Application No. 61/947,416, entitled MOUNTING ASSEMBLIES and filed on Mar. 3, 2014, the contents of which are incorporated herein by specific reference.

### BACKGROUND OF THE INVENTION

1. The Field of the Invention

The present invention relates to devices for mounting objects. More specifically, the present invention relates to mounting assemblies that can be used for mounting objects such as signs, boards, planks, and the like to posts.

2. The Relevant Technology

T-posts are a type of fence support commonly used by ranchers and farmers. These sturdy posts are made of metal, have a generally t-shaped profile when viewed from above, are typically painted green or red with a white tip, and typically measure anywhere from four to eight feet in length. T-posts are also used for a variety of other purposes besides fencing.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope. In the drawings, like numerals designate like elements. Furthermore, multiple instances of an element may each include separate letters appended to the element number. For example two instances of a particular element “20” may be labeled as “20a” and “20b”. In that case, the element label may be used without an appended letter (e.g., “20”) to generally refer to every instance of the element; while the element label will include an appended letter (e.g., “20a”) to refer to a specific instance of the element.

FIG. 1 is a perspective view of a mounting assembly according to one embodiment;

FIGS. 2A-2D are back, side, front, and top views, respectively, of the mounting assembly shown in FIG. 1;

FIG. 3 is a cross sectional top view of the mounting assembly of FIG. 1 attached to a t-post, with a sign attached to the mounting assembly;

FIGS. 4 and 5 are back and front views, respectively, of the mounting assembly of FIG. 1 attached to a t-post, with a sign attached to the mounting assembly;

FIG. 6 is a perspective view of a mounting assembly according to another embodiment;

FIGS. 7A-7C are front, side, and top views, respectively, of the mounting assembly shown in FIG. 6;

FIG. 8 is a cross sectional top view of the mounting assembly of FIG. 6 attached to a t-post, with a sign attached to the mounting assembly;

FIG. 9 is a cross sectional side view of the clip shown in FIG. 6;

FIG. 10 is a front view of the mounting assembly of FIG. 7 attached to a t-post, with a sign attached to the mounting assembly;

FIG. 11 is a top view of a of a mounting assembly according to another embodiment;

FIG. 12 is a perspective view of a portion of a main body of the mounting assembly shown in FIG. 11;

FIGS. 13-13D are front, top, back, and side views, respectively, of the main body of the mounting assembly shown in FIG. 11;

FIG. 14 is a top view of the mounting assembly of FIG. 11 attached to a t-post, with a sign attachable to the mounting assembly;

FIGS. 15 and 16 are front and back views, respectively, of the mounting assembly of FIG. 11 attached to a t-post, with a sign attached to the mounting assembly;

FIGS. 17A and 17B are top and side views, respectively, of a portion of a mounting assembly according to another embodiment;

FIGS. 18A-18C illustrate one embodiment of a clamp holder usable with the mounting assembly of FIG. 17A;

FIGS. 19A-19C illustrate another embodiment of a clamp holder usable with the mounting assembly of FIG. 17A;

FIGS. 20A-20C illustrate another embodiment of a clamp holder usable with the mounting assembly of FIG. 17A; and

FIGS. 21A-21C illustrate various views of a pet carousel according to one embodiment.

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein. It will also be understood that any reference to a first, second, etc. element in the claims or in the detailed description is not meant to imply numerical sequence, but is meant to distinguish one element from another unless explicitly noted otherwise.

In addition, as used in the specification and appended claims, directional terms, such as “top,” “bottom,” “up,” “down,” “upper,” “lower,” “proximal,” “distal,” “horizontal,” “vertical,” and the like are used herein solely to indicate relative directions and are not otherwise intended to limit the scope of the invention or claims.

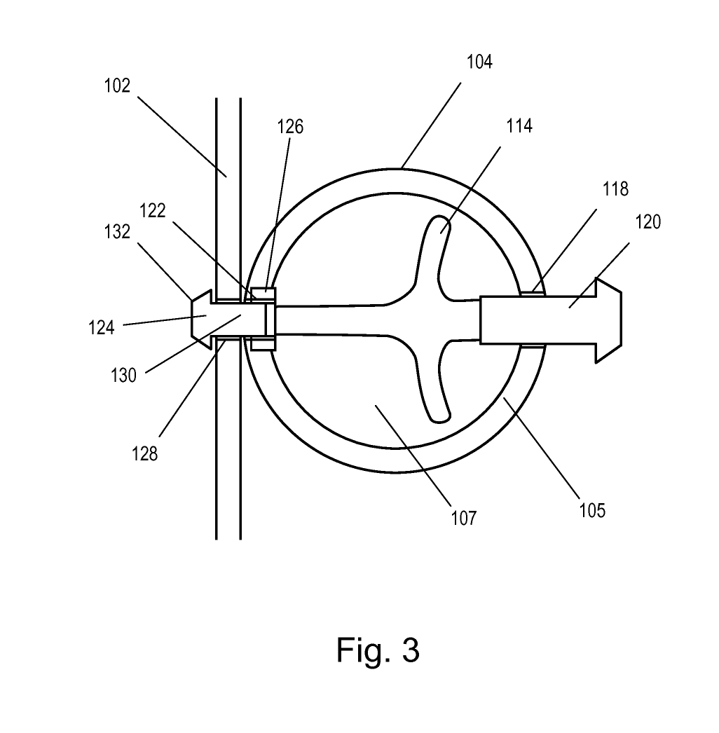

The present application relates to devices for mounting objects to posts. Embodiments of the present invention relate to mounting assemblies that can be used for mounting objects such as signs, panels, planks, boards and the like to posts, and in particular to t-posts. T-posts are a type of fence support commonly used by ranchers and farmers. These sturdy posts are typically made of metal and have a generally t-shaped profile when viewed from above, such as t-post 114 depicted in FIG. 3. T-posts are often painted green or red with a white tip, and typically measure anywhere from four to eight feet in length. T-posts are also used for a variety of other purposes besides fencing.

Although the mounting assemblies of the present application are discussed herein primarily for use with t-posts, it should be appreciated that the mounting assemblies can also be used with other types of posts. Similarly, although the mounting assemblies are discussed herein primarily for use in mounting signs, it should be appreciated that the mounting assemblies can also be used to mount other types of objects. For example, panels, planks, boards, and the like can be mounted using embodiments of the present application. Other objects may also be mountable. It should also be appreciated that the mounting assemblies discussed herein can also be used for other purposes besides mounting At least one embodiment disclosed herein is directed to a use other than for mounting.

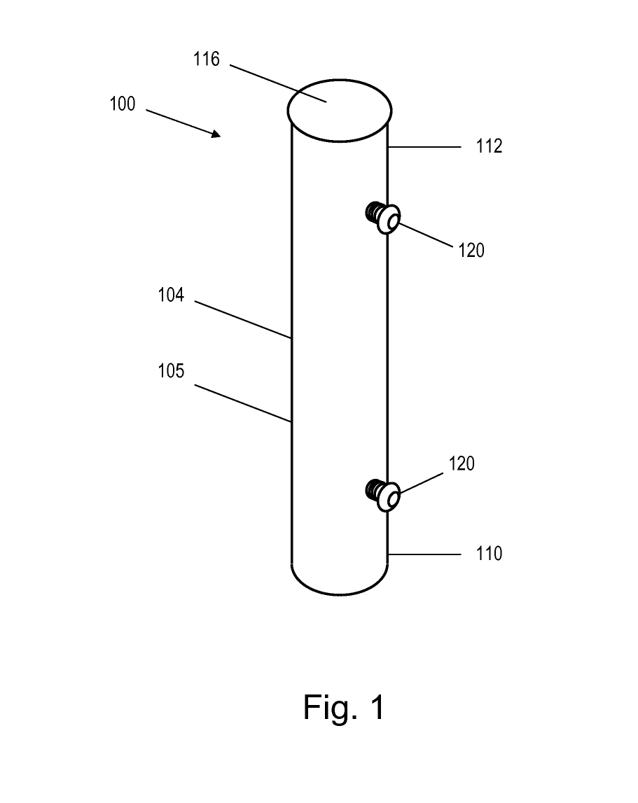

FIGS. 1-5 depict one embodiment 100 of a mounting assembly to which an object, such as a sign or the like, can be attached. As depicted in FIG. 1, mounting assembly 100 comprises a tubular body 104 that is sized and shaped so as to slide over the top end of a t-post. Body 104 extends longitudinally from a bottom end 110 to a top end 112. Body 104 comprises a tubular sidewall 105 that bounds a central aperture 107 (FIG. 3) that also extends between the bottom and top ends 110 and 112. Central aperture 107 is sized to receive the t-post therein. As a result, body 104 can be slid down the t-post to a desired position, with the t-post being received within aperture 107. The cross-sectional shape of aperture 107 can be circular, oval, oblong, rectangular, or any other shape that allows tubular body 104 to receive and longitudinally slide along the t-post. An optional cap 116 can be attached to body 104 at top end 112 to prevent body 104 from sliding down the t-post past the top end of the t-post. To accomplish this, cap 116 can cover the central aperture, either fully or partially, at top end 112. Without the cap, body 104 might slide down t-post 114 past the top end.

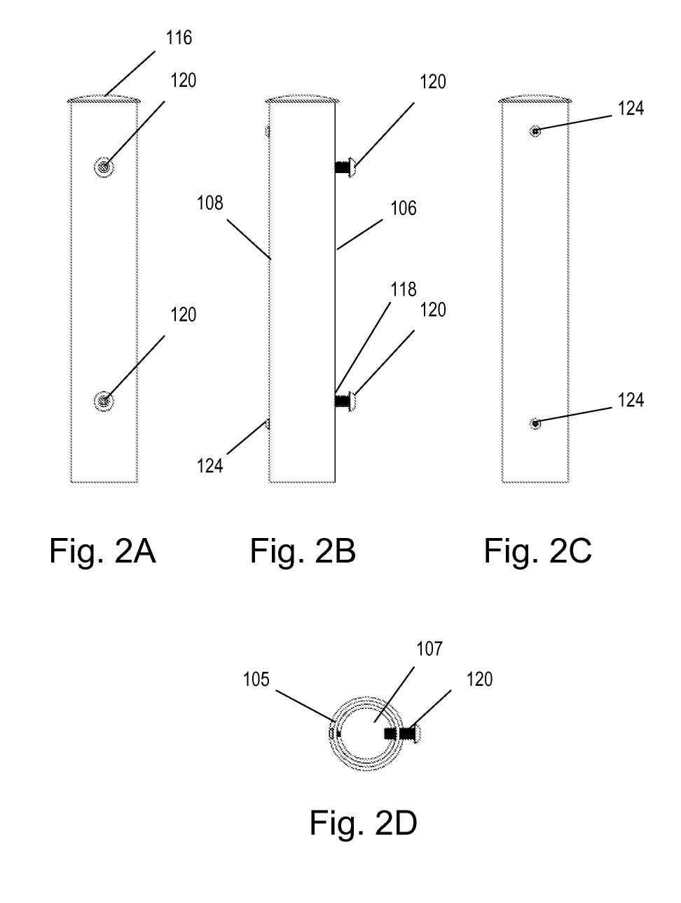

Body 104 can be thought of as having a back side 106 and a front side 108 extending from bottom end 110 to top end 112. FIGS. 2A and 2C respectively show the front and back sides of body 104. Body 104 can include one or more throughholes that extend into sidewall 105 toward central aperture 107.

For example, turning to FIG. 3 in conjunction with FIGS. 2A-2D, body 104 can include one or more threaded throughholes 118 on back side 106 for use in attaching body 104 to the post. In one embodiment, there are a plurality of throughholes 118 on body 104. Throughholes 118 can be vertically aligned with each other so to be aligned as with the t-post. Although only two throughholes 118 are shown in the depicted embodiment, it should be appreciated that any number of throughholes 118 can be used. It should also be appreciated that throughholes 118 can themselves be threaded or threaded inserts can be secured within or behind throughholes 118.

Body 104 can also include one or more threaded throughholes 122 on front side 108 for use in securing an object, such as a sign or the like, to body 104. In one embodiment, there are a plurality of throughholes 122 on body 104. Throughholes 122 can be vertically aligned with each other if desired. Although only two throughholes 122 are shown in the depicted embodiment, it should be appreciated that any number of throughholes 122 can be used. It should also be appreciated that throughholes 122 can themselves be threaded or threaded inserts, such as insert 126 depicted in FIG. 3, can be secured within or behind throughholes 122.

Mounting assembly 100 further comprises one or more fasteners attachable to the back side of the tubular body for removably securing body 104 to the post. As such these fasteners will be referred to herein as post fasteners. In the depicted embodiment the post fasteners are screws or bolts 120 threadable into tubular body 104, e.g., by being threaded into throughholes 118. To secure body 104 to the post, each bolt 120 can be threaded into its corresponding throughhole 118 until the end of the bolt pushes against the post. For example, in FIG. 3 bolt 120 has been threaded into throughhole 118 to secure body 104 to t-post 114.

Mounting assembly 100 also comprises one or more fasteners attachable to the front side of the tubular body for removably securing an object, such as sign or the like, to securing body 104. As such these fasteners will be referred to herein as object fasteners. In the depicted embodiment the object fasteners are screws or bolts 124 threadable into tubular body 104, e.g., by being threaded into throughholes 122. To secure an object to body 104, the threaded end of the bolts or screws 124 can be passed through the object and threaded into throughholes 122. For example, in FIG. 3, screw 124 has been threaded into throughhole 122 to secure a sign 102 to body 104.

To help mount the object to the mounting assembly, the object can have holes that are alignable with the throughholes of body 104. For example, as shown in FIG. 3, sign 102 has holes 128 that align with throughholes 122. To secure sign 102 to body 104, sign 102 can be positioned against body 104 so that holes 128 are aligned with throughholes 122. Screws 124 can be passed through holes 128 in sign 102 and threaded into throughholes 122. Holes 128 are sized so as to allow the threaded portions 130 of screws 124 to pass therethrough, but not the heads 132. As such, when screws 124 are threaded into throughholes 122, heads 132 can secure sign 102 to body 104, as shown in FIG. 3.

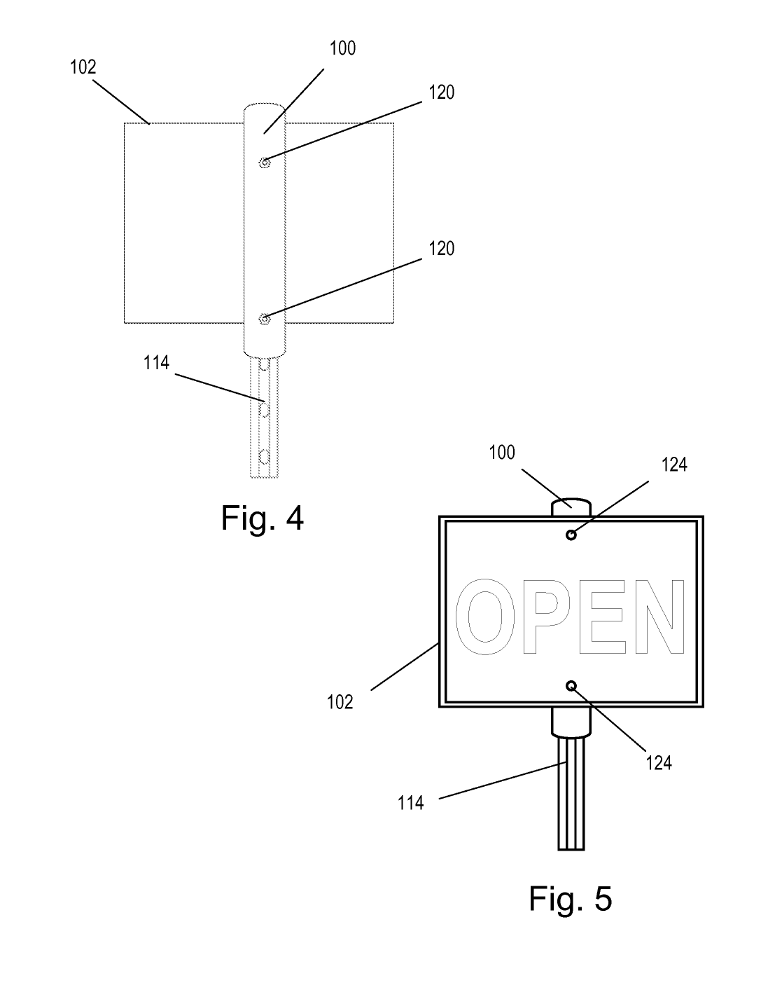

By securing the object to body 104 and body 104 to the post, e.g., in the manner discussed above, mounting assembly 100 can effectively secure the object to the post. FIGS. 4 and 5 depict rear and front views, respectively of mounting assembly 100 being employed in such a manner to secure sign 102 to t-post 114.

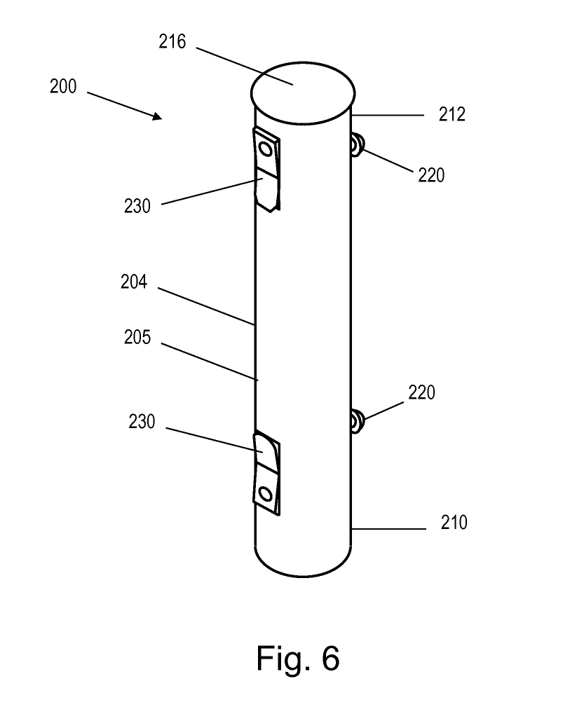

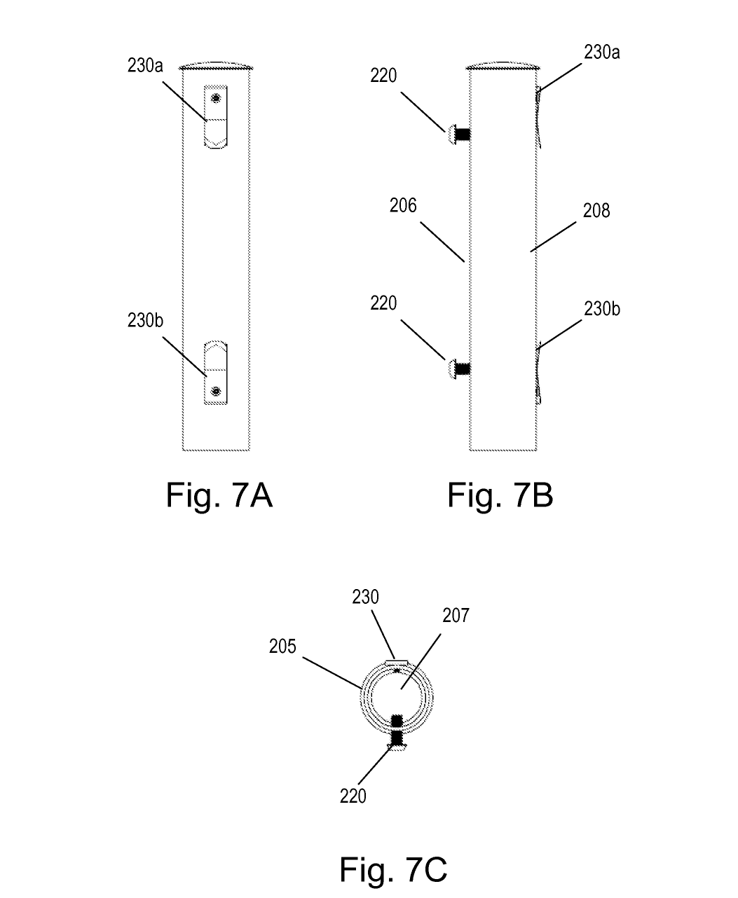

FIGS. 6-10 depict another embodiment 200 of a mounting assembly. As depicted in FIGS. 6-7C, mounting assembly 200 is similar to mounting assembly 100 in many respects. For example, mounting assembly 200 also comprises a body 204 having a tubular sidewall 205 bounding a central aperture 207 (FIG. 9) extending longitudinally from a bottom end 210 to a top end 212. Aperture 207 can have any cross-sectional shape discussed above so as to be able to slide over the top end of the t-post. An optional cap 216 similar to cap 116 discussed above can be attached to body 204 at top end 212.

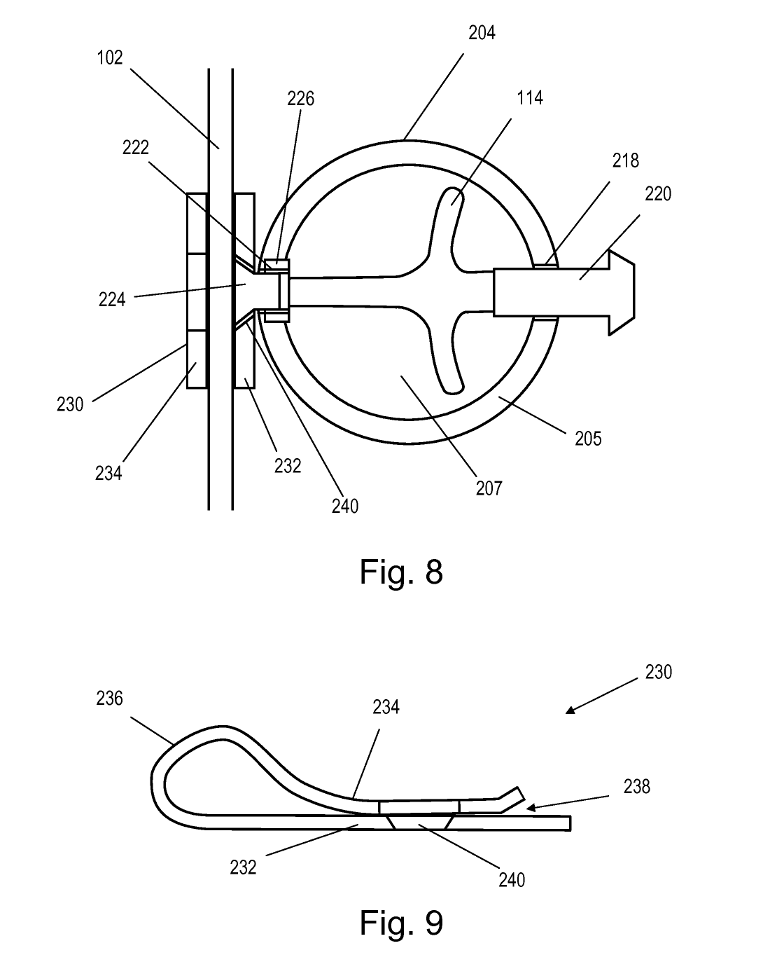

Similar to body 104, body 204 can also be thought of as having a back side 206 and a front side 208 extending from bottom end 210 to top end 212. FIG. 7A depicts the front side of body 204. Back side 206 is similar to back side 106 discussed above. Thus, body 206 can also include one or more threaded throughholes 218 on back side 206 into which one or more screws or bolts 220 can be threaded to secure body 204 to a post, as shown in FIG. 8. Front side 208 is similar to front side 108 discussed above. Thus, body 204 can also include one or more threaded throughholes 222 on front side 208 into which one or more bolts or screws 224 can be threaded.

In mounting assembly 200, however, the object fasteners comprise more than just the bolts or screws. They also comprise clips that are attached to the body. Thus, instead of securing the object directly to body 204, screws 224 can be used to secure clips 230 to the body. is the object can then be secured within the clips.

As shown in FIG. 9, each clip 230 includes a first arm 232 and a second arm 234 each extending from a different end of a coupling portion 236 so as to form a mouth 238. Coupling portion 236 is biased to cause first and second arms 232 and 234 to push towards each other and, in some embodiments, to push directly against each other along a portion thereof. When the object is inserted through mouth 238 so as to be positioned between first and second arms 232 and 234, the biasing force between first and second arms 232 and 234 secures the object therebetween, e.g., in securing sign 102 as shown in FIG. 8.

A mounting hole 240 can be positioned on first arm 232 through which screw 224 can be passed to secure clip 230 to body 204 by threaded connection. Hole 240 can be countersunk, as depicted, to allow a corresponding countersunk screw 224 to be used so that screw 224 can sit flush, or nearly flush, with first arm 232, although this is not required. Other manners of attaching the clip to body 204 are also possible.

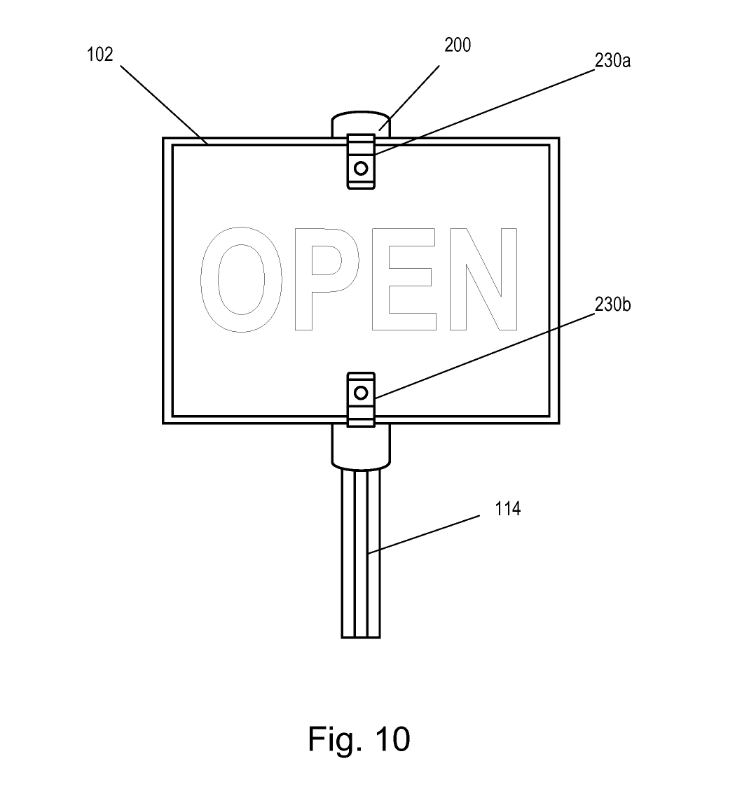

Any number of clips can be used. In the depicted embodiment, a pair of clips 230a and 230b are used to secure sign 102 to the post, as shown in FIG. 10. Clips 230a and 230b are positioned so that their respective mouths face each other. That is, the top clip (230a) is positioned so that the mouth thereof faces downward and the bottom clip (230b) is positioned so that the mouth thereof faces upward. This arrangement can secure sign 102 within clips 230a and 230b while preventing sign 102 from unintentionally vertically slipping out of the clips.

Once clips 230 are secured to body 104, the object can be secured to body 104 by inserting the object through mouth 238 of each clip 230 so that the object becomes positioned between first and second arms 232 and 234 of each clip.

Using clips can provide some advantages over other embodiments. For example, the object being mounted needs no holes when using clips to secure the object to the mounting clip, Furthermore, the object can be easily secured and subsequently removed from the clips without tools.

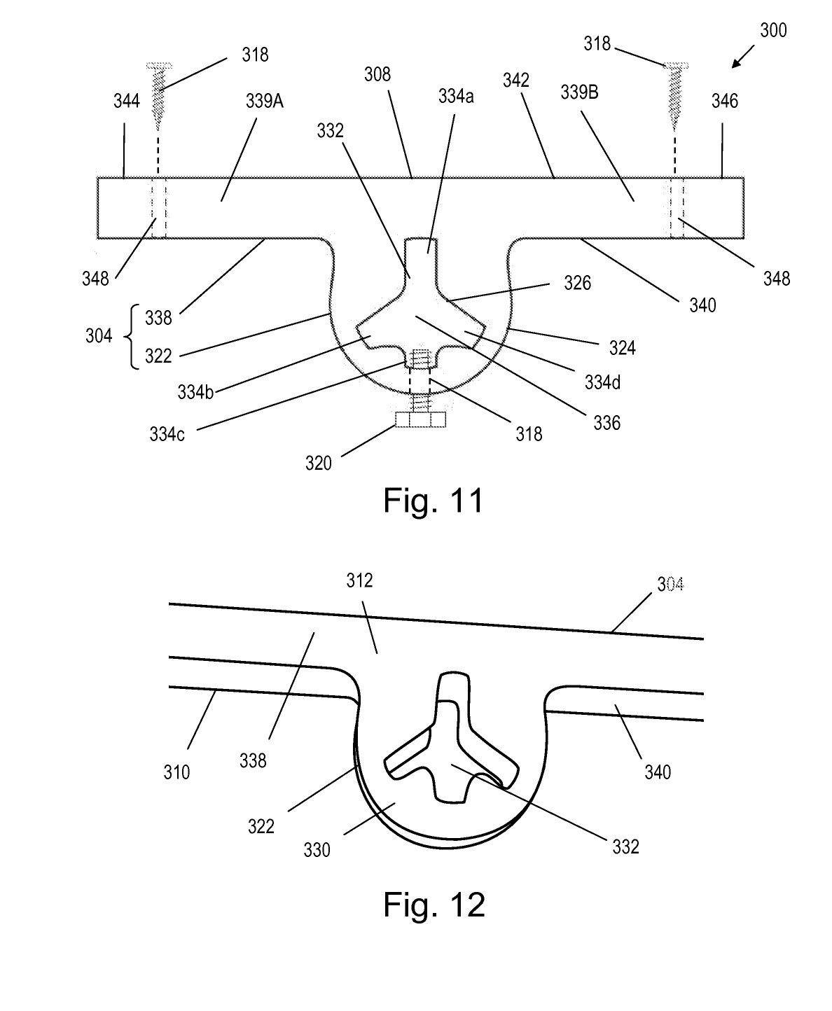

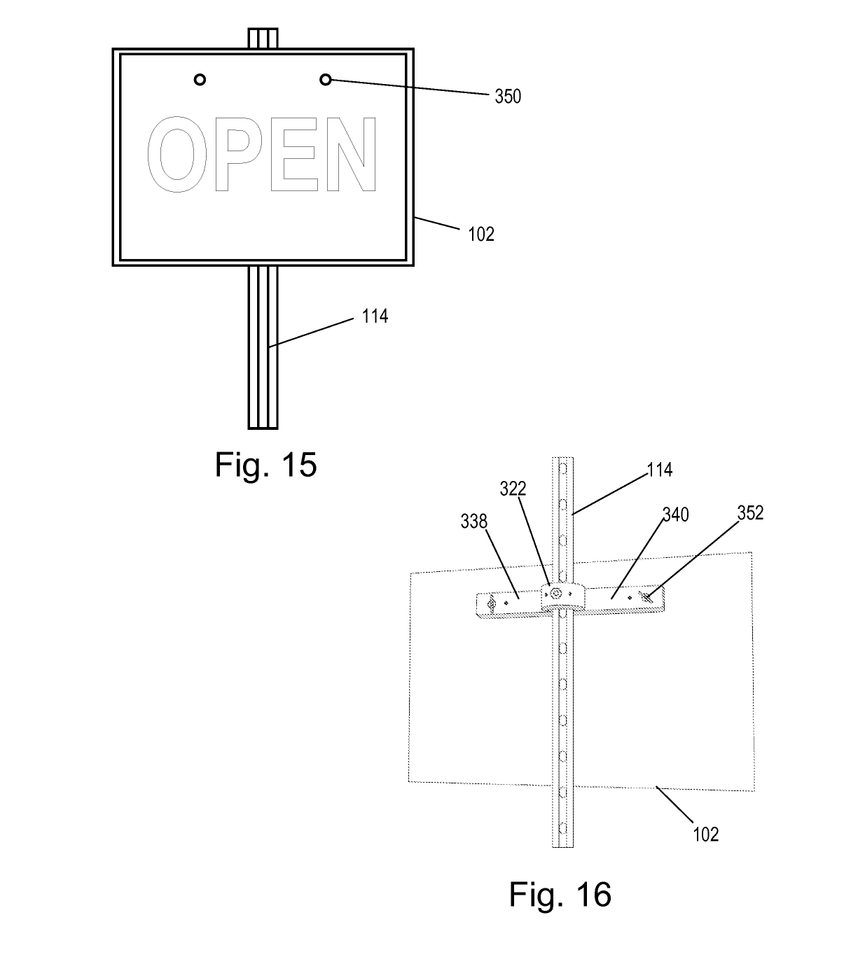

FIGS. 11-16 depict another embodiment 300 of a mounting assembly. As depicted in FIGS. 11 and 12, mounting assembly 300 comprises a main body 304 and a plurality of fasteners, 318 and 322 insertable thereinto. For the same reasons discussed above, fasteners 318 and 322 will respectively be referred to herein as post fasteners and object fasteners.

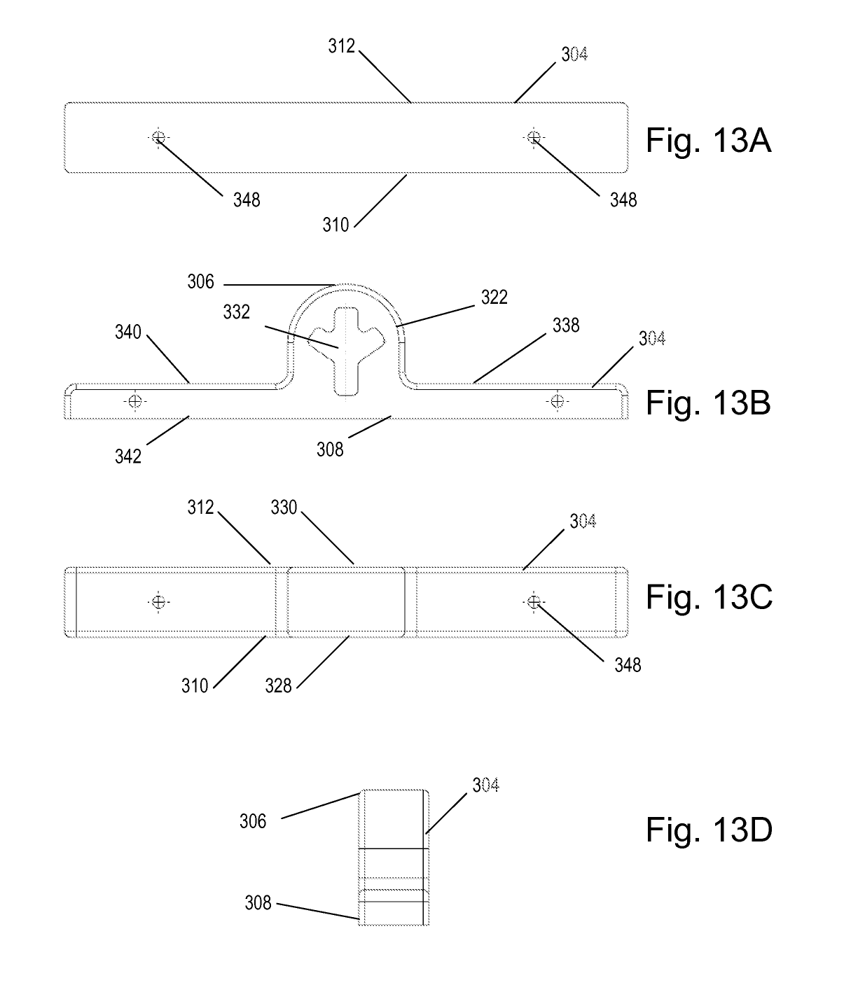

FIGS. 13A-13D depict various views of main body 304. As shown in FIG. 11 in conjunction with FIGS. 13A-13D, main body 304 has a back side 306 and a front side 308. and comprises first and second portions, 322 and 338 extending upward from a bottom end 310 to a top end 312. First portion 322 is used for mounting body 304 to the post. As such, first portion 322 will be referred to herein as the post mounting portion. Second portion 338 is used for mounting the object to body 304. As such, second portion 338 will be referred to herein as the object mounting portion.

Post mounting portion 322 comprises an outer surface 324 and an opposing inner surface 326 extending from a bottom surface 328 at bottom end 310 to a top surface 330 at top end 312. Inner surface 326 bounds an aperture 332 that extends completely through post mounting portion 322 between the top and bottom surfaces 328 and 330. Aperture 332 is sized and shaped to receive the post therein. Aperture 332 can be of any size and shape that will allow mounting assembly 300 to receive and longitudinally slide along the post. Thus, aperture 332 can be circular, oval, oblong, rectangular, or any other shape.

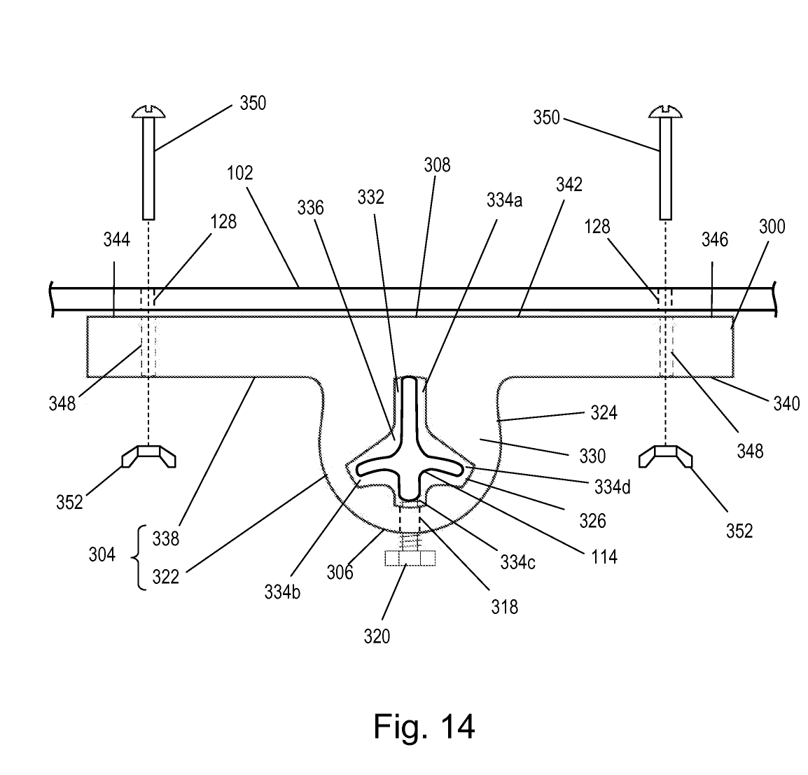

In one embodiment aperture 332 has a non-symmetrical cross sectional shape for a better fit with the post. For example, in the depicted embodiment, aperture 314 is generally shaped to match the cross-sectional shape of a t-post. As such, aperture 314 includes four arm-like chambers 334 (334a-334d) extending outward from a central chamber 336. One of the arm-like chambers (334c) extends toward back side 306. Each of the arm-like chambers 334 corresponds to one of the cross sectional arms oft-post 114, as shown in FIG. 14. As such, body 304 can slide over the top end of t-post 114 and slide vertically along t-post 114 only when arm-like chambers 334 are aligned with the arms of t-post 114. This can prevent rotation of body 304 about t-post 114 when attached thereto.

As shown in FIG. 11, post mounting portion 322 can include a throughhole 318 extending laterally from back side 306 into aperture 332. Similar to througholes 118 and 218 discussed above, throughhole 318 can threadedly receive a post fastener, e.g., bolt 320, to secure body 304 to the post. Throughhole 318 can be aligned with chamber 334c so so as to be aligned with the back of t-post 114 when the t-post is positioned within aperture 332, e.g., as shown in FIG. 14. This can secure body 304 to the t-post in a similar manner to that discussed above. It should be appreciated that throughhole 318 can be threaded or a threaded insert can be secured within or behind throughholes 318 for bolt 320 to thread into, similar to that discussed above.

Object mounting portion 338 comprises a pair of arms 339 (339A, 339B) extending in generally opposite lateral directions from post mounting portion 322 at front side 308 of body 304. Object mounting portion 338 has a back side 340 and a front side 342 each extending laterally from a first end 344 to a second end 346. During use, the object is secured to object mounting portion 338 at the front side 342.

Object mounting portion 338 includes a plurality of throughholes 348 at least one at each end 344 and 346 that extend from front side 342 to back side 340 so as to be generally orthogonal to aperture 332. Similar to throughholes 122 and 222 discussed above, throughholes 348 can receive the object fasteners, e.g., screws 318, to secure the object to body 304. In one embodiment, fasteners 318 are threaded into throughholes 348 to secure the object, in a similar manner to that discussed above. In another embodiment, depicted in FIG. 14 bolts, such as bolts 350 can be passed through throughholes 348 so their ends extend beyond back side 340. A threaded nut, such as wingnut 352, can be threaded onto the end of each bolt and tightened to secure the object, such as sign 102, to object mounting portion 338.

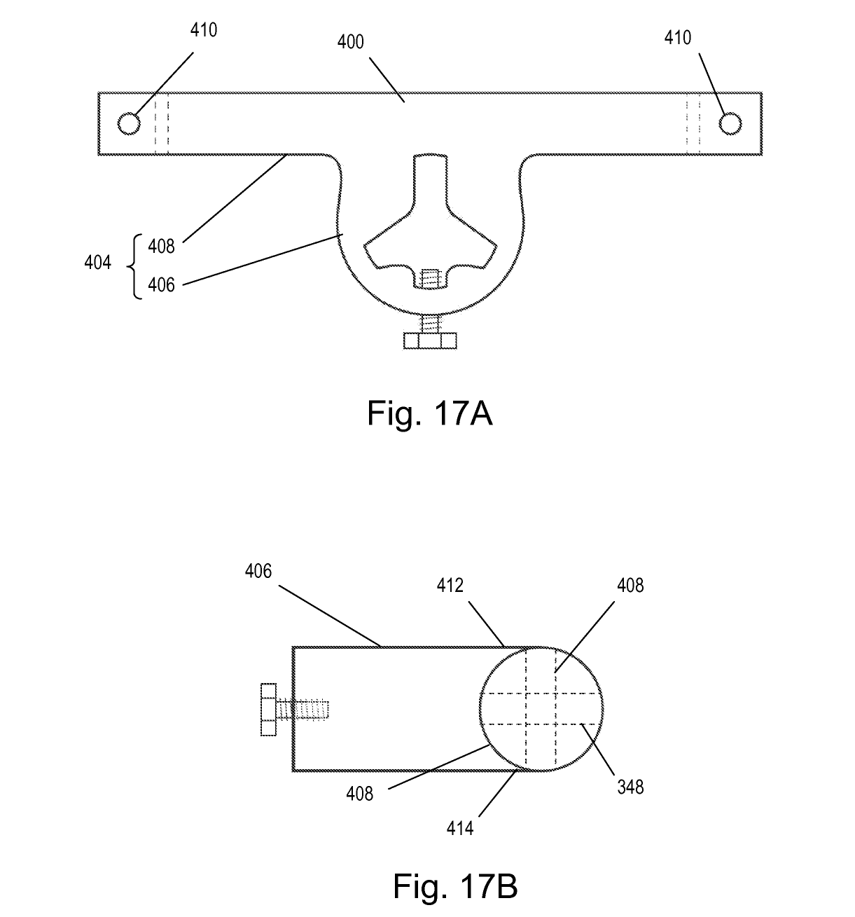

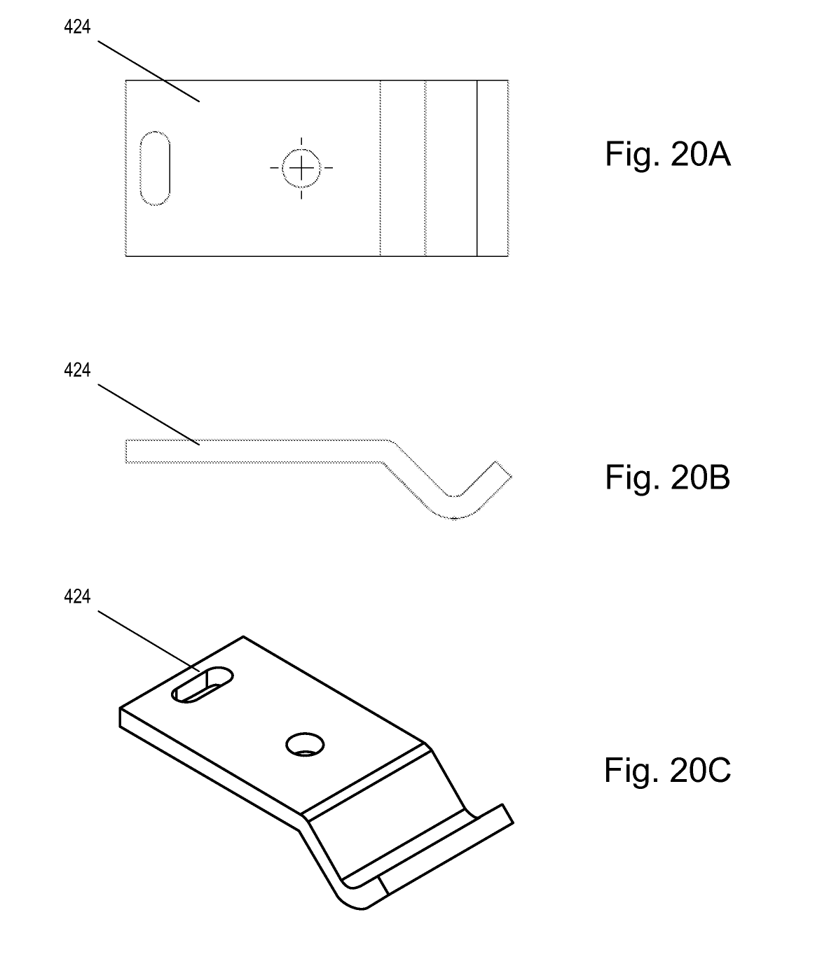

FIGS. 16 and 17 respectively depict front and rear views of mounting assembly 300 being employed to secure sign 102 to t-post 114. Although two bolts 350 and corresponding wingnuts 352 are shown in FIG. 20, it should be appreciated that any number of throughholes 348 and corresponding bolts 350 and nuts 352 can be used. It should also be appreciated that other types of fasteners can be used. Furthermore, throughholes 348 can be laterally aligned on mounting bar 338, although this is not required.

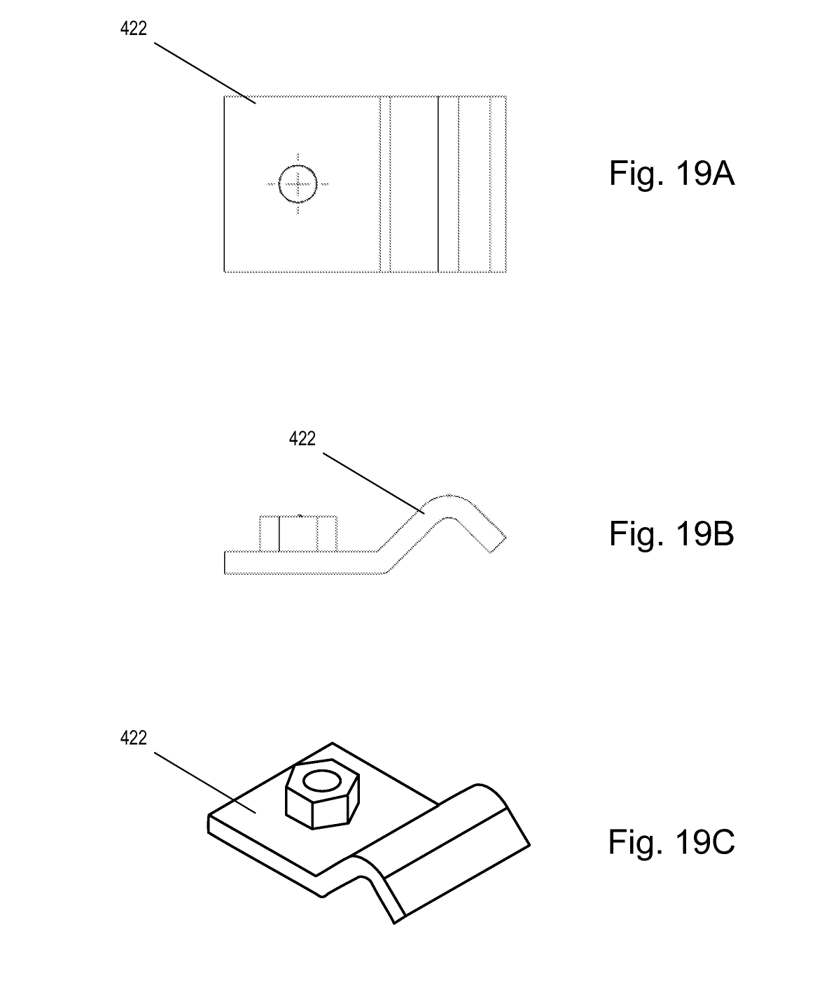

Because of the stability provided by the arms of object mounting portion 338 and the shape of aperture 332, a single mounting assembly 300 may be all that is necessary for mounting an object, such as sign 102 depicted in FIGS. 19 and 20. However, any number of mounting assemblies 300 can be used to mount an object. For example, for a particularly large and/or heavy board or plank and/or in windy conditions, first and second mounting assemblies 300 can be respectively positioned at the top and bottom of a object to provide extra support. Of course, more than two mounting assemblies 300 can also be used.

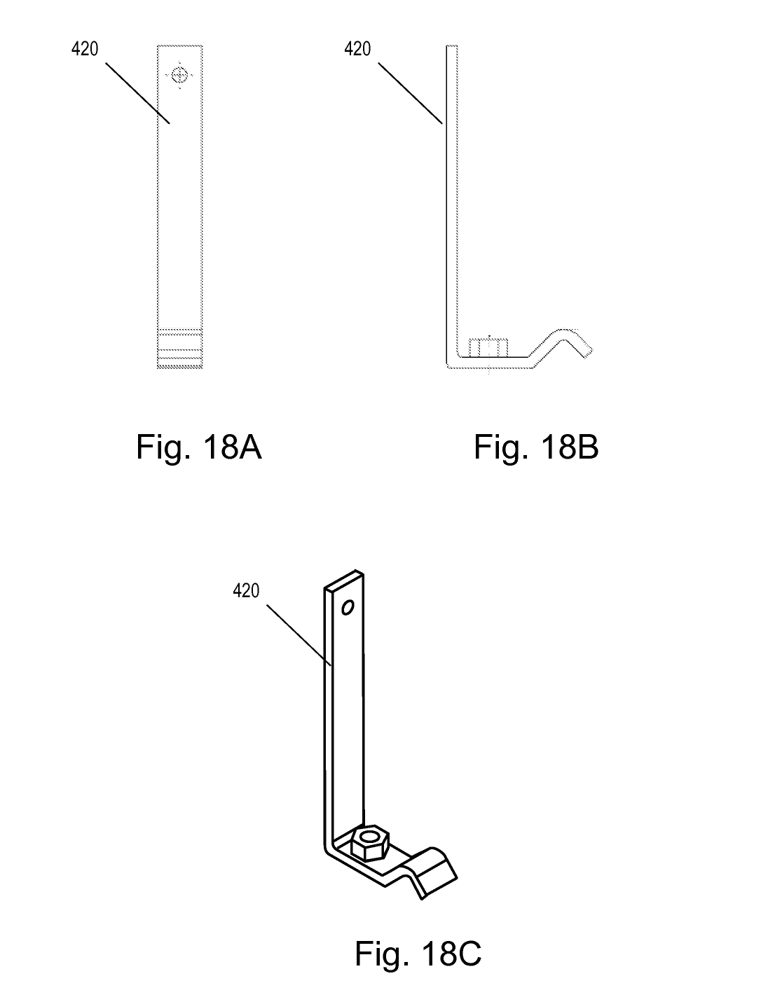

FIGS. 17A and 17B disclose another embodiment 400 of a mounting assembly. Similar to mounting assembly 300, mounting assembly 400 includes a body 404 having a post mounting portion 406 and a object mounting portion 408. Post mounting portion 406 is substantially the same as post mounting portion 322. Object mounting portion 408 is similar to object mounting portion 338, except that a pair of throughholes 410 extend through object mounting portion 408 between top and bottom surfaces 412 and 414 thereof. Thus, instead of being generally orthogonal to the aperture, as are throughholes 348, throughholes 410 are generally parallel to the aperture. This allows a number of other types of mounting devices to be usable with the mounting assembly. For example, FIGS. 18A through 20C illustrate various types of clamp holders 420, 422, 424 that can be attached to mounting bar 408 using throughholes 410.

A threaded screw or nut can be threaded into throughhole 410 or into a nut that is inserted into throughhole 410 or that is positioned on bottom surface 414 of mounting bar 408, in manners similar to those discussed above. As a result, the clamp holders can rotate about the bolts in through-holes 410 before being secured to body 404. This may be beneficial as it can allow objects mounted thereon to be rotated to face any desired direction. The object mounting portion can have throughholes 410 instead of throughholes 348 or, as depicted, can have both types of throughholes.

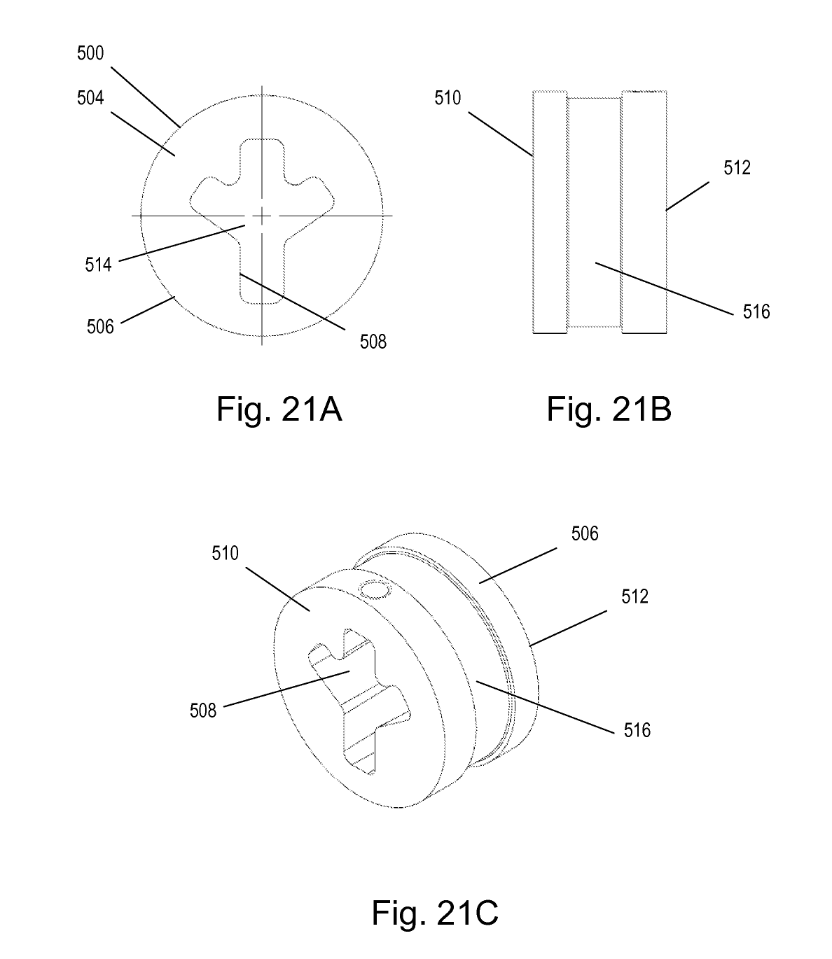

As noted above, the mounting assemblies disclosed or envisioned herein can be used for more than just the mounting of objects. For example, FIGS. 21A to 21C depict one embodiment 500 of a pet carousel 500 that uses elements of the present invention. Pet carousel 500 comprises a body 504 having an outer surface 506 and an inner surface 508 each extending between top and bottom surfaces 510 and 512. Inner surface 508 bounds an aperture 514 that can be similarly sized and shaped as aperture 332. Outer surface 506 bounds an annular channel 516 that can receive a tether, such as a cable, a rope, a mesh line, or the like, for tethering an animal Channel 516 smoothly encircles body 504 so that the tether will not become entangled with the t-post. Instead, when the animal moves around the t-post, the tether will also move around the t-post with the animal by moving within the channel.

The present invention may be embodied in other specific forms without departing from its spirit or essential characteristics. Accordingly, the described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A mounting assembly adapted to secure a object to a post, the mounting assembly comprising:
a tubular body bounding a central aperture, the body and the central aperture extending longitudinally from a bottom end to a top end, the tubular body having a front side and a back side;
one or more post fasteners attachable to the back side of the tubular body, the post fasteners being configured to removably secure the tubular body to the post; and
one or more object fasteners attachable to the front side of the tubular body, the object fasteners being configured to removably secure the object to the tubular body.

2. The mounting assembly recited in claim 1, wherein the object fasteners are configured to removably secure a sign to the tubular body.

3. The mounting assembly recited in claim 1, further comprising a cap positioned at the top end of the tubular body, the cap at least partially covering the central aperture.

4. The mounting assembly recited in claim 1, wherein the cross-sectional shape of the central aperture is circular, oval, oblong, or rectangular.

5. The mounting assembly recited in claim 1, wherein the one or more post fasteners each comprises a screw or bolt threadable into the tubular body.

6. The mounting assembly recited in claim 1, wherein the tubular body has one or more throughholes positioned on the back side of the tubular body, and each of the one or more post fasteners is attachable to the tubular body by threaded connection with a corresponding one of the throughholes or with a threaded insert positioned within the throughhole, such that threading the post fasteners into the throughholes or corresponding inserts secures the mounting assembly to the post.

7. The mounting assembly recited in claim 1, wherein the one or more object fasteners each comprises a threaded screw or bolt threadable into the tubular body.

8. The mounting assembly recited in claim 1, wherein the tubular body has one or more throughholes positioned on the front side of the tubular body, and each of the one or more object fasteners is attachable to the tubular body by threaded connection with a corresponding one of the throughholes or with a threaded insert positioned within the throughhole, such that threading the object fasteners into the throughholes or corresponding inserts secures the object to the tubular body.

9. The mounting assembly recited in claim 1, wherein the one or more object fasteners each comprises a clip attached to the tubular body.

10. The mounting assembly recited in claim 1, wherein the one or more object fasteners comprises a plurality of clips attached to the tubular body, each clip having a mouth adapted to receive a object, and wherein the mouths of two of the clips face each other.

11. The mounting assembly recited in claim 1, wherein the tubular body has one or more throughholes positioned on the front side of the tubular body, and wherein the one or more object fasteners comprises one or more clips, each clip being attached to the tubular body by threaded connection with a corresponding one of the throughholes or with a threaded insert positioned within the throughhole.

12. A mounting assembly adapted to secure a sign to a post having a non-symmetrical cross sectional shape, the mounting assembly comprising:
a main body comprising:
a post mounting portion that bounds an aperture extending vertically therethrough between a bottom surface and a top surface, the aperture being non-symmetrically shaped and configured to receive the post, the post mounting portion having a throughhole extending laterally therethrough and into the aperture; and
a object mounting portion extending laterally from the post mounting portion, the object mounting portion having a plurality of throughholes extending therethrough;
a post fastener attachable to the post mounting portion through the throughhole therein, the post fastener being configured to removably secure the mounting assembly to the post; and
a plurality of object fasteners attachable to the object mounting portion through the throughholes therein, the object fasteners being configured to removably secure the object to the object mounting portion.

13. The mounting assembly recited in claim 12, wherein the object fasteners are configured to removably secure a sign to the object mounting portion.

14. The mounting assembly recited in claim 12, wherein the object fasteners each comprises a screw or bolt threadable into the object mounting portion by threaded connection with a corresponding one of the throughholes therein or with a threaded insert positioned within the throughhole, such that threading the object fasteners into the throughholes or corresponding inserts secures the object to the object mounting portion.

15. The mounting assembly recited in claim 12, wherein the object mounting portion comprises a pair of arms extending in generally opposite lateral directions from the post mounting portion, and wherein the throughholes of the object mounted portion are positioned on both arms.

16. The mounting assembly recited in claim 12, wherein the object fasteners each comprises a bolt and corresponding nut, such that passing the bolt through the corresponding throughhole of the object mounting portion and threading the bolt into the nut secures the sign to the object mounting portion.

17. The mounting assembly recited in claim 12, wherein the throughholes of the object mounting portion extend horizontally therethrough.

18. The mounting assembly recited in claim 12, wherein the throughholes of the object mounting portion extend vertically therethrough.

19. The mounting assembly recited in claim 18, further comprising a plurality of clamp holders attachable to the object mounting portion via the object fasteners, the clamp holders being laterally rotatable about the object fasteners.
